(19) United States
(12) Patent Application Publication
(10) Pub. No.: US 2016/0013825 A1
(43) Pub. Date: Jan. 14, 2016

(54) WIRELESS DEVICE ATTACHING BAND, AND WIRELESS DEVICE

(71) Applicant: SHARP KABUSHIKI KAISHA, Osaka-shi, Osaka (JP)

(72) Inventor: Tomofumi KATAYAMA, Osaka-shi (JP)

(73) Assignee: Sharp Kabushiki Kaisha, Osaka-shi, Osaka (JP)

(21) Appl. No.: 14/770,504

(22) PCT Filed: Jul. 1, 2014
(86) PCT No.: PCT/JP2014/067564

§ 371 Date: Aug. 26, 2015

(30) Foreign Application Priority Data
Aug. 27, 2013 (JP) 2013-176067

(51) Int. Cl. H04B 1/3827

(52) U.S. Cl. CPC H04B 1/385; H04B 2001/3866

(57) ABSTRACT

A wireless device attaching band (bracelet (20)) is provided with an exposed conductive section (links (21a, 21b, 22a, 22b, 23a, and 23b)) which is exposed on a side opposite to a target object in a case where a wireless device (wireless circuit (31)) is attached to the target object. The exposed conductive section is caused to serve as an antenna (32) of the wireless device (wristwatch-type wireless device (1a through 1h)). This makes it possible to improve a reception sensitivity characteristic of the wireless device that is provided with the wireless device attaching band having an antenna function.

### TECHNICAL FIELD

The present invention relates to a wireless device attaching band for attaching a wireless device to a target object and a wireless device provided with the wireless device attaching band.

### BACKGROUND ART

Conventionally, a wristwatch-type wireless device provided with a band (bracelet) including an antenna has been known.

For example, Patent Literature 1 discloses a band for a wristwatch-type wireless device. This band is formed by (i) performing insert-molding in which an antenna plate is inserted inside an insulating layer made of synthetic rubber and (ii) covering the outside of the insulating layer with a metal band.

### CITATION LIST

### Patent Literature

Patent Literature 1

Japanese Patent Application Publication, Tokukaihei, No. 5-003446 (Publication date: Jan. 8, 1993)

### SUMMARY OF INVENTION

### Technical Problem

However, a technique disclosed in Patent Literature 1 has the following problem. That is, the band for the wristwatch-type wireless device has the metal band on an outer surface of the band, and this metal band adversely affects reception of signals by the antenna plate provided inside the band for the wristwatch-type wireless device. This deteriorates a reception sensitivity characteristic of the wireless device.

The present invention is attained in view of the above problem, and an object of the present invention is to improve a reception sensitivity characteristic of a wireless device provided with a wireless device attaching band having an antenna function.

### Solution to Problem

The wireless device attaching band according to one aspect of the present invention for attaching a wireless device to a target object, includes: an exposed conductive section made of a conductive member, the exposed conductive section being provided to at least part of an exposed surface of the wireless device attaching band, which exposed surface is on a side opposite to the target object in a case where the wireless device of the wireless device attaching band is attached to the target object, the exposed conductive section serving as an antenna of the wireless device.

### Advantageous Effects of Invention

According to the above arrangement, the exposed conductive section is provided at the exposed surface on the side opposite to the target object in a case where the wireless device is attached to the target object, and the exposed conductive section is caused to serve as the antenna. Accordingly, no member influencing a reception sensitivity characteristic of the antenna is present between the antenna and the exposed surface of the wireless device attaching band. This makes it possible to improve the reception sensitivity characteristic of the antenna (32).

### BRIEF DESCRIPTION OF DRAWINGS

FIG. 1 is an explanatory diagram schematically illustrating an arrangement of a wristwatch-type wireless device according to Embodiment 1 of the present invention.

FIG. 2 is an explanatory diagram schematically illustrating an arrangement of a wristwatch-type wireless device according to Embodiment 2 of the present invention.

FIG. 3 is an explanatory diagram schematically illustrating an arrangement of a wristwatch-type wireless device according to Embodiment 3 of the present invention.

FIG. 4 is an explanatory diagram schematically illustrating an arrangement of a wristwatch-type wireless device according to Embodiment 4 of the present invention.

FIG. 5 is an explanatory diagram schematically illustrating an arrangement of a wristwatch-type wireless device according to Embodiment 5 of the present invention.

FIG. 6 is an explanatory diagram schematically illustrating an arrangement of a wristwatch-type wireless device according to Embodiment 6 of the present invention.

FIG. 7 is an explanatory diagram schematically illustrating an arrangement of a wristwatch-type wireless device according to Embodiment 7 of the present invention.

FIG. 8 is an explanatory diagram schematically illustrating an arrangement of a wristwatch-type wireless device according to Embodiment 8 of the present invention.

### DESCRIPTION OF EMBODIMENTS

### Embodiment 1

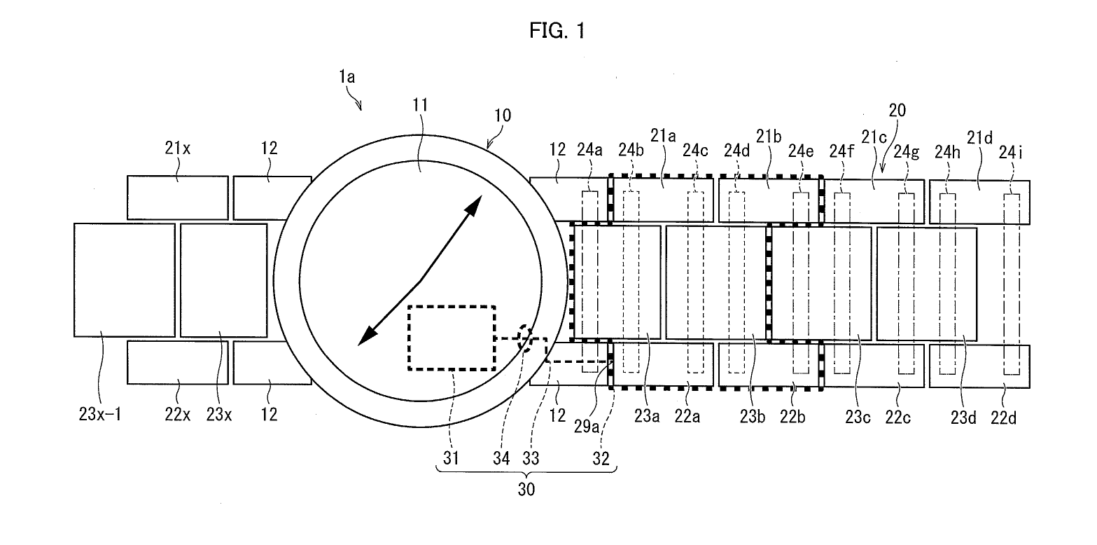

The following discusses one embodiment of the present invention. FIG. 1 is an explanatory diagram schematically illustrating an arrangement of a wristwatch-type wireless device (wireless device) 1a according to Embodiment 1.

The wristwatch-type wireless device 1a includes a case 10, a bracelet 20, and a wireless section (wireless device) 30, as illustrated in FIG. 1.

The case 10 includes a timepiece section 11 provided with a dial, clock hands and the like, a windshield, a crown, a bezel, and the like. Further, the case 10 is provided, to a peripheral section of the case 10, with lugs 12 for attaching the bracelet 20.

The case 10 also includes therein a wireless circuit 31 that is a part of the wireless section 30. The timepiece section 11 is not particularly limited in arrangement, but can be, for example, an analog timepiece section or a digital timepiece section. Furthermore, the lugs 12 can be integrally formed with the case 10 or attached to the case 10.

The bracelet (wireless device attaching band) 20 is connected to the lugs 12 provided to the case 10 by a shaft 24a. The bracelet 20 is wrapped around an arm of a user. Thereby, the bracelet 20 is worn around the arm of the user. Note that the bracelet 20 can include a buckle (fastener, not illustrated) so that the bracelet 20 may be kept wrapped around the arm of the user.

In Embodiment 1, the bracelet 20 is arranged such that each of links 21 (21a, 21b, 21c, . . . 21x), corresponding one of links 22 (22a, 22b, 22c, 22d, . . . , 22x), and corresponding one of links 23 (23a, 23b, 23c, 23d, . . . 23x) are connected to one another by corresponding one of shafts (connecting member) 24 (24a, 24b, 24c, 24d . . . ). For simplification, some of the shafts are note illustrated in FIG. 1.

Each of the above links (the links 21, 22, and 23) is made of a conductive member such as metal or the like. Further, the shafts 24b, 24c, and 24d are made of a conductive member such as metal or the like, and the other shafts 24a, 24e, 24f, . . . are made of a non-conductive member such as a non-conductive resin or the like.

The above links each have a surface opposed to another member (other link, a lug 12, or the case 10) and a back surface (a surface which comes in contact with a human body at the time when a user wraps the bracelet 20 around the arm). The surface opposed to another member and the back surface are electrically insulated from the outside by an insulating member such as a coating material, a coating, or a resin member. In a case where the links are formed so as to be apart from one another at the time when the bracelet 20 is wrapped around the arm, the surface facing another member does not necessarily include the insulating member.

Links in a region enclosed by a broken line in FIG. 1, that is, each of the links 21a, and 21b is electrically connected to corresponding ones of 22a, 22b, 23a and 23b by corresponding one of the shafts 24b, 24c, and 24d made of the conductive member. On the other hand, the above links are electrically insulated from the other links, the lugs 12, the case 10, and the human body.

The link 22a is provided with a connecting section 29a for connecting, to an antenna 32, a wiring section (feeder) 33 connected to the wireless circuit 31. Note that the connecting section 29a can be formed by use of a flat spring, a sliding contact or the like, so as to keep the wiring section 33 and the link 22a connected to each other even in a case where a position or an angle of the link 22a (the antenna 32) relative to the lugs 12 changes. Alternatively, at the connecting section 29a, the wiring section 33 and the link 22a can be connected each other by welding, bonding with a conductive adhesive, or the like. Furthermore, (i) a connecting section between the wiring section 33 and the wireless circuit 31 or (ii) a path of the wiring section 33 from the wireless circuit 31 to the connecting section 29a can be provided with a flat spring, a sliding contact or the like.

In Embodiment 1, the links (the exposed conductive sections) 21a, 21b, 22a, 22b, 23a, and 23b each have an exposed surface on a side opposite to the arm of the user in a case where the user wraps the bracelet 20 around the arm. These links are made of a conductive member. Each of the links 21a and 21b is connected to corresponding ones of the lines 22a, 22b, 23a, and 23b by corresponding one of the shafts (the connecting member) 24b, 24c, and 24d. In addition, the links 21a, 21b, 22a, 22b, 23a, and 23b are electrically connected to the wireless section 30 via the connecting section 29a and the wiring section 33. This causes each of the links 21a, 21b, 22a, 22b, 23a, and 23b to serve as the antenna 32 of the wireless section 30.

The wireless section 30 includes the wireless circuit 31, the antenna 32, the wiring section 33, and a water stop section 34.

The wireless circuit 31 is provided inside the case 10 as described above. Further, the wireless circuit 31 supplies power to each section of the wireless section 30 and processes signals having been received and signals to be sent.

The antenna 32 includes some of the links constituting the bracelet 20, as described above. The antenna 32 (i) sends, to the outside, a signal having been transmitted from the wireless circuit 31 and (ii) transmits, to the wireless circuit 31, signals having been received from the outside.

The wiring section 33 electrically connects the wireless circuit 31 to the antenna 32 via a through hole provided in the case 10 and one of the lug 12. Note that the wiring section 33 is insulated from the case 10 and the lugs 12.

The water stop section 34 is made of, for example, an O-ring. The water stop section 34 seals the through hole through which the wiring section 33 runs in the case 10, thereby preventing water, dust or the like from entering into the case 10 via the through hole.

As described above, the wristwatch-type wireless device 1a of Embodiment 1 is arranged such that some links among conductive links constituting the bracelet 20 is caused to serve as the antenna 32. This makes it possible to use, as the antenna 32, a conductive member (the exposed conductive section) exposed on a surface side of the bracelet 20 (a side of the bracelet 20 which side is not in contact with a human body in a case where a user wraps the bracelet 20 around an arm of the user (a side opposite to the human body)). Accordingly, unlike a conventional technique described above, no member disturbing reception of signals is present on a surface side of the antenna in the above arrangement. This can improve a reception sensitivity characteristic of the antenna. Further, it becomes possible to form surfaces of the links with metal. This provides a wider choice of materials for the bracelet 20. Further, the bracelet 20 can have an improved design.

In Embodiment 1, the links 21a, 21b, 22a, 22b, 23a, and 23b used as the antenna 32 are assumed to be made of metal. However, the present invention is not limited to this arrangement. The links can be connected to each other so that a length of the antenna can be changed appropriately so as to correspond to a frequency band to be used. The wristwatch-type wireless device 1a can be arranged in any way as long as (i) at least part of an exposed surface on a surface side (a side which is not in contact with a human body in a case where a user wraps the bracelet 20 around an arm of the user) of the links constituting the antenna 32 is made of a conductive member and (ii) the conductive member serves as the antenna 32. If, for example, a ¼λ inverted-L antenna is to be designed, a length of the antenna is set to approximately 9 cm in a case of a frequency band of 800 MHz, and approximately 4 cm in a case of a frequency band of 2 GHz. The links are connected so as to have a required length, so that the antenna corresponding to each frequency band can be obtained.

Further, Embodiment 1 has discussed an arrangement in which three links are connected along a direction perpendicular to a direction in which the bracelet 20 extends. However, the arrangement of the bracelet 20 is not limited to the above arrangement. It is possible to alter as appropriate the number, a shape, a layout, and the like of the links.

In addition, in Embodiment 1, the links are connected to one another by corresponding one of the shafts 24a, 24b, 24c, . . . . However, the present invention is not limited to this arrangement. For example, the links can be connected to each other by engaging a protrusion provided to one link and a depression provided to another link. In this case, the protrusion and the depression forming a connection between the links used as the antenna 32 should be made of a conductive member, while a connection with the other links or the lugs 12 should be made of a non-conductive member.

### Embodiment 2

The following discusses another embodiment of the present invention. For convenience of description, a member having a function identical to that of a member discussed in Embodiment 1 above is given an identical reference sign, and a description thereof is omitted.

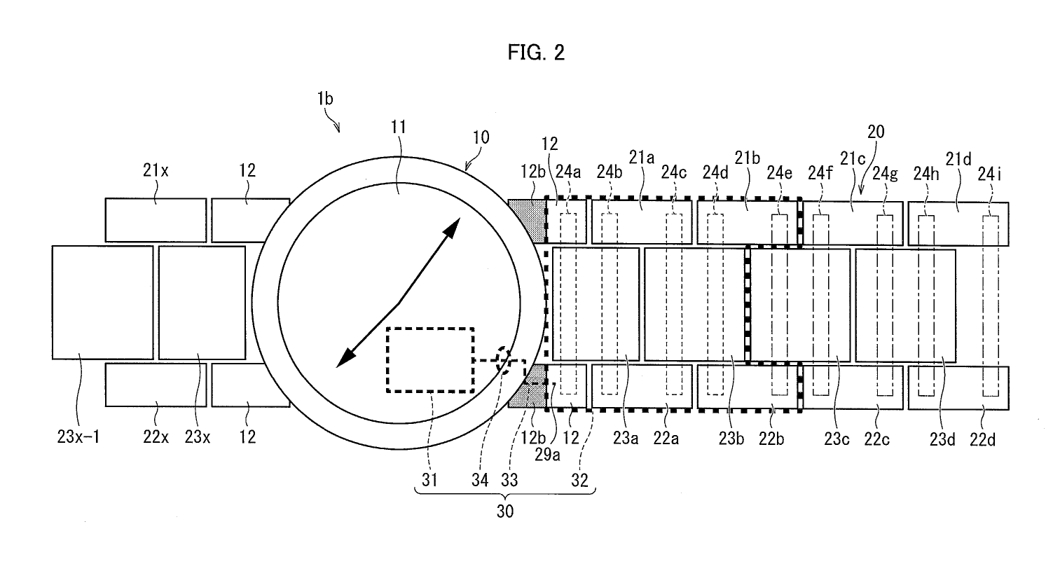

FIG. 2 is an explanatory diagram schematically illustrating an arrangement of a wristwatch-type wireless device (wireless device) 1b according to Embodiment 2. The wristwatch-type wireless device 1b of Embodiment 2 differs from the wristwatch-type wireless device 1a of Embodiment 1 in that (i) a non-conductive section 12b is provided between a case 10 and each of lugs 12 and (ii) a shaft 24a is made of a conductive member. The non-conductive section 12b can be made of, for example, a non-conductive resin material or the like.

The wristwatch-type wireless device 1b of Embodiment 2 is arranged such that lugs (exposed conductive section) 12 are electrically connected to links (exposed conductive section) 21a, 21b, 22a, 22b, 23a, and 23b via shafts (connecting members) 24a, 24b, 24c, and 24d, so that the lugs 12 and the links 21a, 21b, 22a, 22b, 23a, and 23b serve as an antenna 32. This makes it possible to improve both a reception sensitivity characteristic of the antenna and a design, as in Embodiment 1.

Further, in Embodiment 2, it is possible to provide, to one of the lugs 12, a connecting section 29a between the antenna 32 and a wiring section 33. This makes it possible to (i) shorten a length of the wiring section 33 and (ii) consequently improve signal transmission efficiency through the wiring section 33, as compared to a case where, as in Embodiment 1, (i) the one lug 12 is electrically disconnected from the link 22a and (ii) the connecting section 29a is provided to the link 22a.

### Embodiment 3

The following discusses still another embodiment of the present invention. For convenience of description, a member having a function identical to that of a member discussed in Embodiments 1 and 2 above is given an identical reference sign, and a description thereof is omitted.

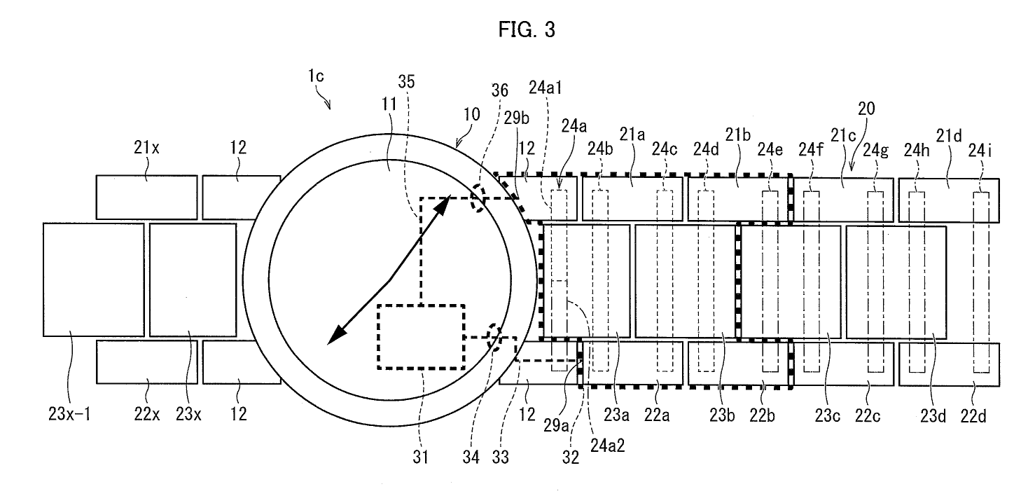

FIG. 3 is an explanatory diagram schematically illustrating an arrangement of a wristwatch-type wireless device (wireless device) 1c according to Embodiment 3. The wristwatch-type wireless device 1c of Embodiment 3 differs from the wristwatch-type wireless device 1a of Embodiment 1 in that: (i) a shaft 24a for connecting a link 23a to lugs 12 has (a) one end portion (a portion in contact with the link 23a and one of the lugs 12 to which one lug a wiring section 33 is not provided) made of a conductive member 24a1 and (b) the other end portion (a portion in contact with the link 23a and the other lug 12 to which the wiring section 33 is provided) made of a non-conductive member 24a2; (ii) a wireless circuit 31 is electrically connected to the lug 12 to which the wiring section 33 is not provided, via a connecting section 29b provided to this lug 12 and a wiring section (a short-circuit line) 35; and (iii) a water stop section 36 is provided which water stop section 36 is for sealing a through hole (not illustrated) through which the wiring section 35 runs in a case 10. The connecting section 29b and the wiring section 35 is not particularly limited in arrangement, but can include, for example, a flat spring, a sliding contact, or the like.

In the above arrangement, as shown by broken line in FIG. 3, the lug 12 to which the wiring section 33 is not provided, and the links 21a, 21b, 22a, 22b, 23a, and 23b serve as an antenna 32. Further, the wiring section 33 serves as a feeder and the wiring section 35 serves as the short-circuit line. Accordingly, the antenna 32 serves as an inverted F antenna. This makes it possible to provide a wider frequency range for receiving signals, in addition to effects similar to those of Embodiment 1.

In Embodiment 3, the wiring section 35 connects the wireless circuit 31 and the lug 12 to which the wiring section 33 is not provided. However, the present invention is not limited to the above arrangement. The present invention can be arranged, for example, by (i) electrically connecting the case 10 and the lug 12 to which the wiring section 33 is not provided and (ii) connecting the case 10 with this lug 12 by the wireless circuit 31.

### Embodiment 4

The following discusses still another embodiment of the present invention. For convenience of description, a member having a function identical to that of a member discussed in Embodiments 1 through 3 above is given an identical reference sign, and a description thereof is omitted.

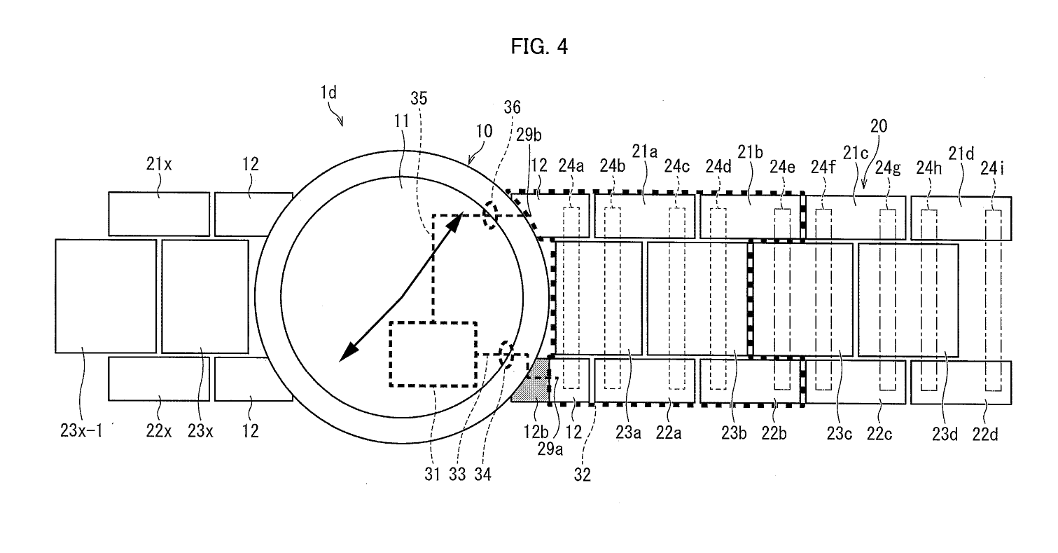

FIG. 4 is an explanatory diagram schematically illustrating an arrangement of a wristwatch-type wireless device (wireless device) 1d according to Embodiment 4. The wristwatch-type wireless device 1d of Embodiment 4 differs from the wristwatch-type wireless device 1c of Embodiment 3 in that: (i) a wiring section 33 is connected to one of lugs 12; (ii) a non-conductive section 12b is provided between a case 10 and the lug 12 to which the wiring section 33 is connected; and (iii) a shaft 24a for connecting a link 23a to the lugs 12 is made of a conductive member such as metal.

In the above arrangement, as illustrated by broken line in

FIG. 4, the lugs 12, the links 21a, 21b, 22a, 22b, 23a, and 23b serve as an antenna 32. Further, the antenna 32 is formed as an inverted F antenna in which the wiring section 33 serves as a feeder and the wiring section 35 serves as a short-circuit line.

The above arrangement makes it possible to obtain effects that are substantially the same as those in Embodiment 3. Further, in Embodiment 4, it is possible to provide, to one of the lugs 12, a connecting section 29a between the antenna 32 and the wiring section 33. This makes it possible to (i) shorten a length of the wiring section 33 and (ii) consequently improve signal transmission efficiency through the wiring section 33, as compared to a case where the connecting section 29a is provided to the link 22a.

### Embodiment 5

The following discusses still another embodiment of the present invention. For convenience of description, a member having a function identical to that of a member discussed in Embodiments 1 through 4 above is given an identical reference sign, and a description thereof is omitted.

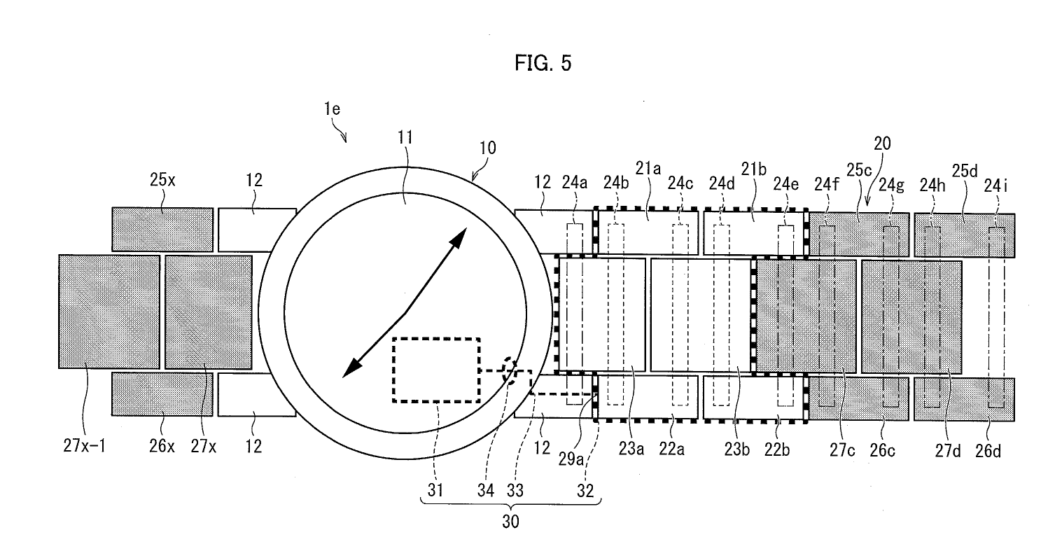

FIG. 5 is an explanatory diagram schematically illustrating an arrangement of a wristwatch-type wireless device (wireless device) 1e according to Embodiment 5. The wristwatch-type wireless device 1e of Embodiment 5 differs from the wristwatch-type wireless device 1a of Embodiment 1 in that the wristwatch-type wireless device 1e employs (i) links made of a conductive material, as links serving as an antenna 32, and (ii) links made of a non-conductive material, as the other links. Specifically, the wrist-watch type wireless device 1e of Embodiment 4 differs from the wrist-watch type wireless device 1a of Embodiment 1 in that the wristwatch-type wireless device 1e includes (i) non-conductive links 25c, 25d, . . . , in place of the links 21c, 21d, . . . made of metal (conductive), (ii) non-conductive links 26c, 26d, . . . , in place of the links 22c, 22d, . . . made of metal (conductive), and (iii) non-conductive links 27c, 27d, . . . in place of the links 23c, 23d, . . . made of metal (conductive).

The above non-conductive links can be, for example, links made of a non-conductive resin or the like. Alternatively, links can be produced by two-color molding (double molding) so that at least an outer surface of each of the links may be made of a non-conductive resin.

The above arrangement of Embodiment 5 makes it possible to obtain effects substantially the same as those in Embodiment 1. Further, the above arrangement of Embodiment 5 also makes it possible to provide a wider choice of materials for the links and to improve a design, as compared to a case where all links are made of metal.

Note that lugs 12, in addition to the links which are not used as the antenna 32, can also be made of a non-conductive member.

### Embodiment 6

The following discusses still another embodiment of the present invention. For convenience of description, a member having a function identical to that of a member discussed in Embodiments 1 through 5 above is given an identical reference sign, and a description thereof is omitted.

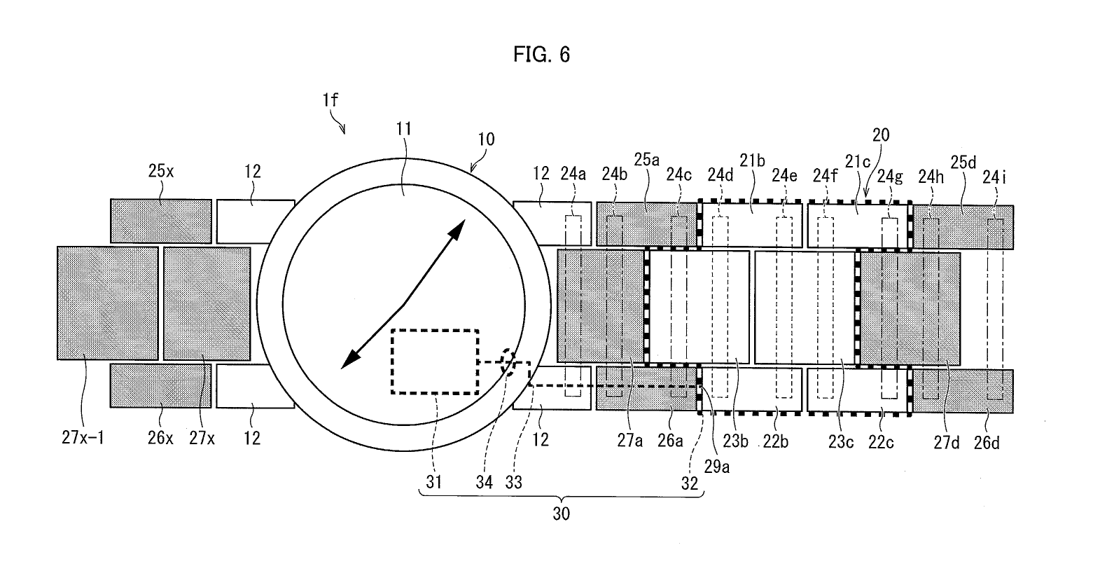

FIG. 6 is an explanatory diagram schematically illustrating an arrangement of a wristwatch-type wireless device (wireless device) 1f according to Embodiment 6. The wristwatch-type wireless device 1f of Embodiment 6 differs from the wristwatch-type wireless device 1a of Embodiment 1 in that: (i) non-conductive links 25a, 25d, . . . are provided in place of the links 21a, 21d, . . . made of metal (conductive); (ii) non-conductive links 26a, 26d, . . . are provided in place of the links 22a, 22d, . . . made of metal (conductive); (iii) non-conductive links 27a, 27d, . . . are provided in place of the links 23a, 23d, . . . made of metal (conductive); (iv) a wiring section 33 is connected to a link 22b via a through hole provided in the link 26a; and (v) shafts 24d, 24e, and 24f are made of a conductive member, whereas the other shafts are made of a non-conductive member.

The above arrangement can cause the links 21b, 21c, 22b, 22c, 23b, and 23c to serve as an antenna 32, thereby providing effects substantially the same as those in Embodiment 1.

Further, the link 26a is made of a non-conductive member. This link 26a is provided with the through hole through which the wiring section 33 runs. This arrangement makes it possible to easily form the through hole (line structure).

In Embodiment 6, positions of the links made of metal (conductivity) for use as the antenna 32 are set to the second link and the third link from a case 10 in a direction (circumferential direction) in which a bracelet 20 extends. However, a position of such a link is not limited to the above arrangement. Such a link can be set to any position. This makes it possible to set, to any position, a position of a link made of a conductive member and a position of a link made of a non-conductive member. This can further improve a design of the bracelet 20.

Furthermore, the above non-conductive links can be, for example, links made of a non-conductive resin, or the like. Alternatively, the above non-conductive links can be produced by two-color molding (double molding). In addition, lugs 12, in addition to links which are not used as the antenna 32, can also be made of a non-conductive member.

### Embodiment 7

The following discusses still another embodiment of the present invention. For convenience of description, a member having a function identical to that of a member discussed in Embodiments 1 through 6 above is given an identical reference sign, and a description thereof is omitted.

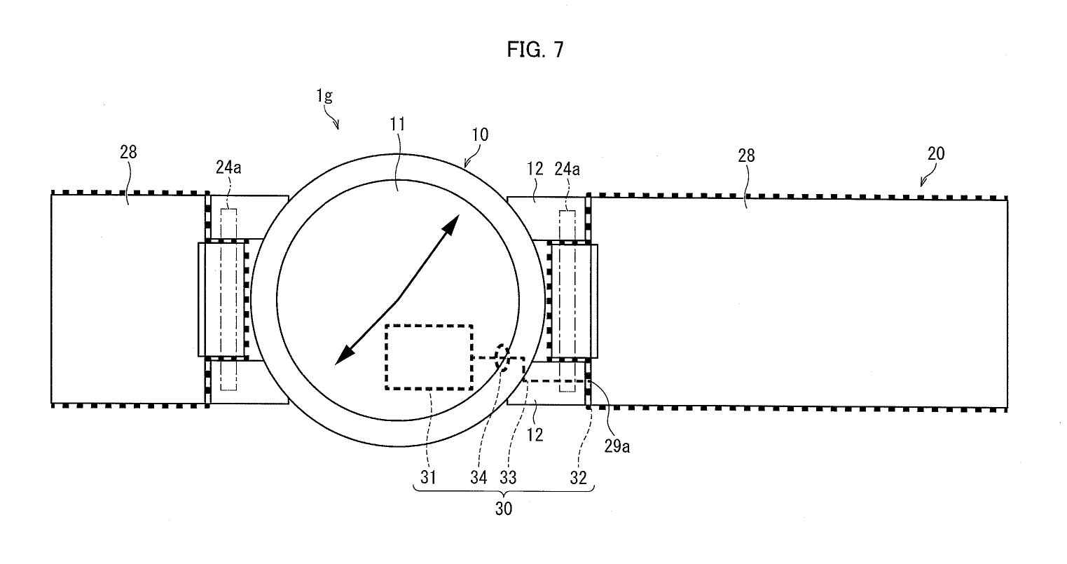

FIG. 7 is an explanatory diagram schematically illustrating an arrangement of a wristwatch-type wireless device (wireless device) 1g according to Embodiment 7.

The wristwatch-type wireless device 1a in Embodiment 1 is arranged such that a plurality of links is connected to form the bracelet 20. On the other hand, the wristwatch-type wireless device 1g of Embodiment 7 is arranged such that a bracelet 20 is formed with a single link 28 as illustrated in FIG. 7.

The link 28 is made of a metal (conductive) member. This link 28 is connected to lugs 12 by a shaft 24a made of a non-conductive member. The link 28 is not particularly limited in material as long as the link 28 has at least an arrangement in which a conductive material comes to an exposed surface on a side opposite to an arm of a user in a case where the user wraps the bracelet 20 around the arm of the user.

The link 28 is electrically connected to a wireless circuit 31 via a wiring section 33 and a connecting section 29a. Note that the link 28 is isolated from the lugs 12.

The above arrangement allows an almost entire surface of the exposed surface of the link 28 to serve as an antenna 32. This exposed surface is a surface of the link 28 which surface comes to the side opposite to the arm of the user in a case where the user wraps the bracelet 20 around the arm of the user. This makes it possible to further improve a reception sensitivity characteristic of the antenna. Further, the entire bracelet 20 can be made of a single material. This makes it possible to simplify a production process and also to improve a design of the bracelet 20.

### Embodiment 8

The following discusses still another embodiment of the present invention. For convenience of description, a member having a function identical to that of a member discussed in Embodiments 1 through 7 above is given an identical reference sign, and a description thereof is omitted.

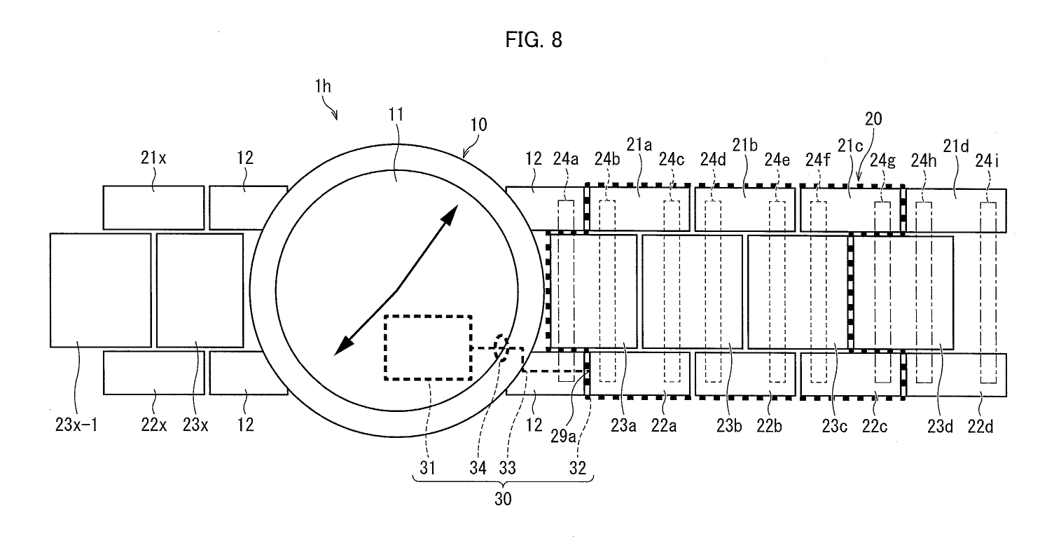

FIG. 8 is an explanatory diagram schematically illustrating an arrangement of a wristwatch-type wireless device (wireless device) 1h according to Embodiment 8. The wristwatch-type wireless device 1h of Embodiment 8 differs from the wristwatch-type wireless device 1a illustrated in FIG. 1 in that in the wristwatch-type wireless device 1h, shafts 24e and 24f, in addition to the shafts 24b, 24c, and 24d are made of a conductive member whereas the other shafts are made of a non-conductive member.

In the above arrangement, each of links 21a, 21b, 21c, corresponding one of links 22a,22b,22c, and corresponding one of links 23a,23b,23c are electrically connected to one another via corresponding one of the shafts 24b through 24f, so that the links serve as an antenna 32, as illustrated in FIG. 8.

This increases a length of the antenna 32 of Embodiment 8 in a direction (circumferential direction) in which a bracelet 20 extends in the wristwatch-type wireless device 1h, as compared to that in the wristwatch-type wireless device 1a of Embodiment 1. This makes it possible to further improve a reception sensitivity characteristic of the antenna.

Note that the number and positions of the links serving as the antenna 32 are not limited to arrangements illustrated in FIG. 1 or FIG. 8. The number and the positions of such links can be appropriately set in accordance with a required reception sensitivity characteristic of the antenna or a requirement in regard to a design, and the like.

In each of the above embodiments, the wristwatch-type wireless device is arranged to include the timepiece section 11 in the case 10. However, the arrangements of the wristwatch-type wireless devices 1a through 1h are not necessarily limited to such an arrangement in which the timepiece section 11 is provided. The wristwatch-type wireless device can include, in placed of the timepiece section 11 (or in addition to the timepiece section 11), for example, a display section for displaying an image (e.g., a still image, a moving image, text information, etc.) in accordance with information obtained via radio communications, an operation menu or the like, an operation input section such as keys or buttons through which a user makes an input for an operation, a sound output section for outputting sound.

The embodiments above have discussed the wristwatch-type wireless devices 1a through 1h each of which is intended to attach a wireless device to use's arm as a target object. However, the target object on which the wireless device of the present invention is to be attached is not limited to the user's arm. The present invention only needs to be arranged to include at least the wireless section (wireless device) 30 and the bracelet (wireless device attaching band) 20 for attaching the wireless section (wireless device) 30 to a target object. For example, the target object can be any of parts of a human body in addition to arms, bags, clothes, vehicle frames, various apparatuses, various structures, etc.

### CONCLUSION

A wireless device attaching band (20) according to Aspect 1 of the present invention for attaching a wireless device (30) to a target object, includes: an exposed conductive section made of a conductive member, the exposed conductive section being provided to at least part of an exposed surface of the wireless device attaching band (20), which exposed surface is on a side opposite to the target object in a case where the wireless device (30) of the wireless device attaching band (20) is attached to the target object, the exposed conductive section serving as an antenna (32) of the wireless device (30).

According to the above arrangement, the exposed conductive section is provided at the exposed surface on the side opposite to the target object in a case where the wireless device (30) is attached to the target object, and the exposed conductive section is caused to serve as the antenna (32). Accordingly, no member influencing a reception sensitivity characteristic of the antenna (32) is present on a surface of the antenna (32). This makes it possible to improve the reception sensitivity characteristic of the antenna (32).

The wireless device attaching band (1a through 1f, and 1h) according to Aspect 2 of the present invention, further includes: a plurality of links (21 through 23 and 25 through 27); and connecting members (24) each for connecting corresponding links among the plurality of links to each other, the exposed conductive section being made of at least some of the plurality of links.

According to above arrangement, the wireless device attaching band (20) is arranged such that the plurality of links (21 through 23 and 25 through 27) are connected by the connecting members (24), and this wireless device attaching band (20) is caused to serve as the antenna (32) of the wireless device. This arrangement makes it possible to improve a reception sensitivity characteristic of the antenna (32).

The wireless device attaching band (20) according to Aspect 3 of the present invention is arranged such that: the some of the plurality of links (21 through 23 and 25 through 27) serve as the antenna (32); the some links serving as the antenna (32) are connected to each other by a corresponding conductive connecting member (24) among the connecting members (24), and the exposed conductive section of one of the some links is electrically connected to the exposed conductive section of another one of the some links, via the corresponding conductive connecting member (24); and (i) one of the some links serving as the antenna (32) and (ii) a corresponding link which does not serve as the antenna (32) are connected to each other by a corresponding non-conductive connecting member (24) among the connecting members (24), and (i) the link serving as the antenna (32) and (ii) the link which does not serve as the antenna (32) are electrically insulated from each other or provided apart from each other.

According to the above arrangement, at least some of the plurality of links (21 through 23 and 25 through 27) can be caused to serve as the antenna (32) and at the same time, the other links can be prevented from influencing a reception characteristic of the antenna (32).

The wireless device attaching band (20) according to Aspect 4 of the present invention is arranged to includes two connecting sections (29a and 29b) for electrically connecting the exposed conductive section to a wireless circuit (31) of the wireless device (30), one (29a) of which connecting sections is connected to a feeder (wiring section 33) and the other one (29b) of which connecting section is connected to a short-circuit line (wiring section 35), so that the exposed conductive section serves as an inverted F antenna.

The above arrangement makes it possible to improve a reception sensitivity characteristic of the antenna (32) and also to provide a wider frequency range.

A wireless device of the present invention includes any one of the above-described wireless device attaching bands (20).

The above arrangement makes it possible to improve a reception sensitivity characteristic of the antenna (32).

The present invention is not limited to the embodiments, but can be altered by a skilled person in the art within the scope of the claims. An embodiment derived from a proper combination of technical means each disclosed in a different embodiment is also encompassed in the technical scope of the present invention. Further, it is possible to form a new technical feature by combining the technical means disclosed in the respective embodiments.

### INDUSTRIAL APPLICABILITY

The present invention relates to a wireless device attaching band having an antenna function and a wireless device provided with the wireless device attaching band.

### REFERENCE SIGNS LIST

1a-1h Wristwatch-type wireless device (wireless device)

10 Case

11 Timepiece section

12 Lug

12b Non-conductive section

20 Bracelet (wireless device attaching band)

21 (21a, 21b, 21c, . . . ) Link

22 (22a, 22b, 22c, . . . ) Link

23 (23a, 23b, 23c, . . . ) Link

24a, 24b, 24c, 24d, . . . Shaft (connecting member)

24a1 Conductive member

24a2 Non-conductive member

25 (25a, 25b, 25c, . . . ) Link

26 (26a, 26b, 26c, . . . ) Link

27 (27a, 27b, 27c, . . . ) Link

28 Link

29a, 29b Connecting section

30 Wireless section (wireless device)

31 Wireless circuit

32 Antenna

33 Wiring section (feeder)

34 Water stop section

35 Wiring section (short-circuit line)

36 Water stop section

1. A wireless device attaching band for attaching a wireless device to a target object, comprising:
an exposed conductive section made of a conductive member, the exposed conductive section being provided to at least part of an exposed surface of the wireless device attaching band, which exposed surface is on a side opposite to the target object in a case where the wireless device of the wireless device attaching band is attached to the target object,
the exposed conductive section serving as an antenna of the wireless device.

2. The wireless device attaching band according to claim 1, further comprising:
a plurality of links; and
connecting members each for connecting corresponding links among the plurality of links to each other,
the exposed conductive section being made of at least some of the plurality of links.

3. The wireless device attaching band according to claim 2, wherein:
the some of the plurality of links serve as the antenna;
the some links serving as the antenna are connected to each other by a corresponding conductive connecting member among the connecting members, and the exposed conductive section of one of the some links is electrically connected to the exposed conductive section of another one of the some links, via the corresponding conductive connecting member; and
(i) one of the some links serving as the antenna and (ii) a corresponding link which does not serve as the antenna are connected to each other by a corresponding non-conductive connecting member among the connecting members, and (i) the link serving as the antenna and (ii) the link which does not serve as the antenna are electrically insulated from each other or provided apart from each other.

4. The wireless device attaching band according to claim 1, further comprising:
two connecting sections for electrically connecting the exposed conductive section to a wireless circuit of the wireless device, one of which connecting sections is connected to a feeder and the other one of which connecting section is connected to a short-circuit line, so that the exposed conductive section serves as an inverted F antenna.

5. A wireless device comprising the wireless device attaching band according to claim 1.
